(19) United States
(12) Patent Application Publication
(10) Pub. No.: US 2015/0375980 A1
(43) Pub. Date: Dec. 31, 2015

(54) CLOSING ELEMENT AND CLOSING MACHINE FOR CLOSING CONTAINERS

(71) Applicant: KHS GmbH, Dortmund (DE)

(72) Inventors: Matthias Naaber, Bretzenheim (DE); Bernd Bruch, Weinsheim (DE)

(21) Appl. No.: 14/769,590

(22) PCT Filed: Jan. 16, 2014
(86) PCT No.: PCT/EP2014/000107

§ 371 Date: Aug. 21, 2015

(30) Foreign Application Priority Data
Feb. 21, 2013 (DE) 10 2013 101 716.9

(51) Int. Cl. B67B 3/20

(52) U.S. Cl. CPC B67B 3/2033

(57) ABSTRACT

A closure element for fastening a closure onto a bottle includes a closing head that accommodates the closure during placement and fastening thereof onto the bottle, a first drive having a first-drive element that causes an axial stroke of the closing head, and a second drive. The axial stroke moves the closing head vertically toward the bottle. The second drive includes a second-drive element that connects to the closing head, thus causing it to fasten the closure to the bottle as it rotates. The second-drive element comprises a second-drive shaft that is rotatable about the vertical axis, and that avoids axial movement during the axial stroke.

### RELATED APPLICATIONS

This application is the national stage under 35 UC 371 of international application PCT/EP2014/000107, filed on Jan. 16, 2014, which claims the benefit of the Feb. 21, 2013 priority date of German application DE 102013101716.9.

### FIELD OF INVENTION

The invention relates container processing, and in particular, to a closing element and to a closing machine.

### BACKGROUND

Known closing elements for screwing caps on bottles include a closing head or closing cone for accommodating a container closure. During a fitting stroke, the closing head or cone places the closure on the container in the region of the container mouth. Then, the closing head or cone places pressure against the container as it rotates. This screws the closure onto the container.

To carry out this function, the closing head must be able to move vertically. This movement is called the “stroke.” In addition, the closing head must be able to rotate.

In known closing elements, a motor drive, such as an electric spindle drive, provides the screwing movement and stroke curves provide the vertical movement.

A disadvantage of the prior art is that it is difficult to exchange stroke curves. This makes it difficult to adjust the placement and pressing stroke or lifting stroke respectively for different container closures and different container heights.

A further disadvantage is that, in many cases, for the placement stroke, the shaft or spindle carrying the closing head must also be moved at precisely the correct times. Known closing elements comprise a multiplicity of moving parts, guides, bearings, and possibly also gear wheels, that impede this. In addition, these parts form regions, such as corners and gaps, that are difficult to access. This results in a contamination risk from microorganisms.

Unfortunately, in the regions where capping takes place, the containers are by definition open and filled with liquid content. Thus, they are uniquely vulnerable to contamination. It is therefore imperative that the region in which the capping operation takes place be kept scrupulously free of microorganisms.

A further disadvantage with known closing machines is that they are not all that suitable for use in sterile, clean, or ultraclean areas. The main impediment to their use in such conditions is that known elements carry out a combination of rotational movement and axial movement. The axial movement creates the risk of contamination by dirt and/or microorganisms that are ferried from outside a clean chamber into the inside of the clean chamber during each stroke.

### SUMMARY

An object of the invention is to provide a closing element that has a simplified and compact design and that reduces contamination risk.

In one aspect, the invention features an apparatus for closing bottles. Such an apparatus includes a closure element for fastening a closure onto a bottle that is held parallel to a vertical axis. The closure element includes a vertical axis, a closing head that accommodates the closure during placement and fastening thereof onto the bottle, a first drive, and a second drive. The first drive includes a first-drive element that causes an axial stroke that results in movement of the closing head in a direction parallel to the vertical axis and toward the bottle. The second drive includes a second-drive element that is connected to the closing head for causing the closing head to rotate about the vertical axis, thereby fastening the closure to the bottle. The second-drive element includes a second-drive shaft that is rotatable about the vertical axis and that avoids axial movement during the axial stroke of the closing head.

In some embodiments, the first drive includes a first-drive shaft. In these embodiments, the first-drive shaft and the second-drive shaft are coaxial with each other. Among these are embodiments are those in which the first-drive shaft and the second-drive shaft are coaxial with the vertical axis.

Embodiments include those in which the first-drive element has a movable guide element that moves along the vertical axis during the stroke movement. In these embodiments, the closing head is rotatably mounted at the guide element and connected to the second-drive shaft in such a way that relative movement is possible between the second-drive shaft and the closing head along the vertical axis during the stroke movement and a rotational direction about the vertical axis during rotation of the second-drive shaft. Among these embodiments are those in which the rotational coupling connects the closing head to the second-drive shaft, thereby allowing the stroke movement.

Other embodiments include a spindle gear arrangement that converts rotational movement into stroke movement. This spindle gear arrangement connects the first-drive shaft to the closing head. In these embodiments, the second-drive element includes a second-drive shaft driven by the second drive about the vertical axis, and the first-drive shaft is driven by the first drive about the vertical axis. During stroke movement of the closing head, neither the first-drive shaft nor the second moves along the vertical axis, Among these embodiments are those in which the first-drive shaft and the second-drive shaft are arranged coaxially with one another and with the vertical axis so that the first-drive shaft encloses the second-drive shaft. Also among these embodiments are those in which the first-drive shaft and the second-drive shaft are arranged coaxially with one another and with the vertical axis, with one of the drive shafts being hollow and enclosing the other.

Some embodiments also include a plunger disposed such that, when the closing head is raised during an axial stroke, the plunger extends into the closing head and ejects a closure that remains held therein. Among these are embodiments in which the first-drive element includes a stroke shaft having a lower end that forms the plunger.

Some embodiments include an aseptic filling and closing system in which the closing element is a constituent of the aseptic filling and closing system.

Other embodiments include a closing machine for closing bottles with screw-type closures. The closing machine includes a rotor, with the closing element being but one of many other identical closing elements disposed on the rotor. Among these are embodiments in which the closing head and the container are disposed in a first region, the first and second drives of the closing element are disposed in a second region that is outside of and sealed from the first region. Only the drive elements of the first and second drives penetrate from the second region into the first region.

Other embodiments include those in which the first drive includes a first-drive element that avoids axial movement during the axial stroke of the closing head, and those in which the first drive includes a first-drive shaft that avoids axial movement during the axial stroke of the closing head.

In yet other embodiments, the first-drive element includes a plunger that can be moved along the vertical axis. In these embodiments, the closing head is rotatably mounted at the plunger and is connected to the second-drive shaft in such a way that relative movement is possible between the second-drive shaft and the closing head in both along the vertical axis during stroke movement and in a rotational direction about the vertical axis during rotation of the second-drive shaft.

Other embodiments include those in which a first-drive shaft and the second-drive shaft are offset from each other. These include embodiments in which the offset is in a radial direction and embodiments in which the offset is in a circumferential direction.

The closing element according to the invention is characterized by, among other features, the fact that an independent drive is provided for each closing element of a closing machine, not only for the fastening or screwing of the respective closure onto the container, i.e. for producing the rotational and screwing movement required for this, but also for the vertical stroke movement (spindle stroke). These drives are further designed in such a way that at least the drive element of a drive, and, in this situation, preferably the drive for the rotational and screwing movement, does not carry out any axial movement in relation to the vertical axis during closing, i.e. during the joining and fastening of the container closure. Instead, it has a spindle or shaft driven in a rotating manner by its drive. As a result, the possibility is provided of arranging the drives outside or above the region in which the closing heads and containers are moving. This simplifies sealing the drive element because it no longer has to move axially.

In one embodiment, the drive element of the drive for the stroke movement and the drive element of the drive for the rotational and screwing movement include a spindle or shaft mounted on bearings that permit rotation but not axial movement. These shafts are then preferably arranged on the same axis in relation to one another. For this purpose at least one shaft is a hollow shaft. A stroke or spindle gear system converts rotational movement of a shaft into axial stroke movement, which then, like the rotational or screwing movement, is produced by an appropriate actuation of the two drives relative to one another. The stroke or spindle gear system is compact and structurally simple. It is arranged, for example, immediately above a closing head or, respectively, in the area in which the containers are also moving, at least with their container opening.

As used herein, the term “essentially” refers to deviations in each case from the exact value concerned by +10%, preferably by +5% and/or deviations in the form of changes that are not of significance for the function.

Further embodiments, advantages, and application possibilities of the invention are derived from the following description of exemplary embodiments and from the figures. In this situation, all the features described and/or represented as images are, individually or in any desired combination, basically the object of the invention, regardless of their summary presentation in the claims or their mutual references. The contents of the claims are also constituent parts of the description.

### BRIEF DESCRIPTION OF THE DRAWINGS

These and other features and advantages of the invention will be apparent from the following detailed description and its accompanying figures, in which

FIGS. 1 to 6 show closing elements with coaxial drive axes; and

FIGS. 7 and 8 show closing elements with non-coaxial drive axes.

### DETAILED DESCRIPTION

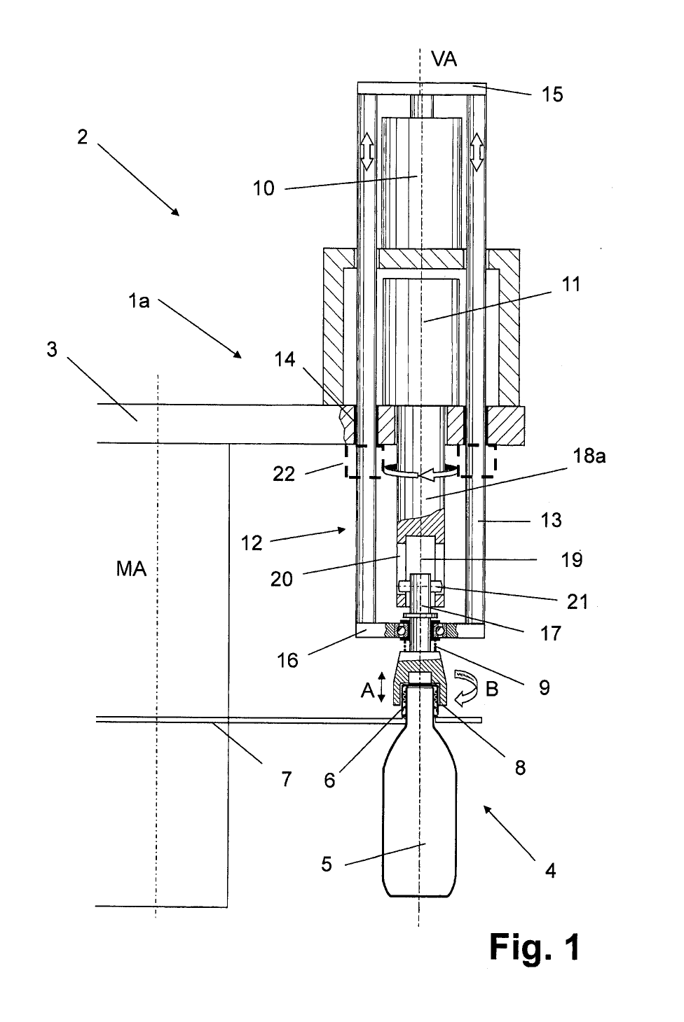

FIGS. 1-6 show a closing machine 2 having a rotor 3 that rotates about a vertical machine axis MA. Closing elements 1a-1f, all of which are the same type, are distributed around a circumference of the rotor 3. The closing machines 2 shown in FIGS. 1-6 differ in the particular type of closing element 1a-1f used.

Each closing element 1a-1f forms a closing position 4 at the circumference of the rotor 3. A closing position 4 is where containers 5, such as bottles, are closed with a container closure 6. The container closure 6, or cap, is a screw closure. Fastening the closure requires rotating it onto a container thread provided in the region of the container opening.

In operation, a container carrier 7 suspends a container 5 from an aperture flange so that the container's axis aligns with the closure element's vertical axis VA beneath a closing element 1a-1f.

Each closing element 1a-1f comprises a closing cone or closing head 8. To avoid redundancy, the term “closing head” will be used with the understanding that the term includes a closing cone.

With the rotor 3 circulating, the closing head 8 picks up a container closure 6 at a closure-issue position of the closing machine 2. The closing head 8 holds the closure 6 in an accommodation element such that the closure 6 faces downward and is ready to be screwed onto a container 5. The closing head 8 holds the closure 5 in a suitable manner, for example by a clamp seat arrangement.

As the rotor 3 continues its rotation, the closing head 8 carries out a downward stroke along a stroke direction A parallel to a vertical axis VA. This lowers the closure 6 onto the container opening of the container 5 that is to be closed. Then, the closing head 8 rotates about the vertical axis VA in a rotation direction B. This screws the closure 6 onto the container 5. The closing head 8 then releases the container closure 6 again by an upward return stroke along the direction A. Two movements of the closing head 8 are thus required to screw the closure 6 onto the container 5: a stroke movement along the stroke direction A, and a rotational movement in the rotation direction B.

In some cases, a closure 6 never makes it onto a container 5. In that case, the closure remains in the closing head 8. This closure 6 must be ejected before the closing head 8 attempts to pick up the next closure 6.

It is also necessary to press the container closure 6 axially downward against the container 5 while screwing it onto the container thread. The required closure-pressing pressure is generally provided by a spring, the details of which are omitted from the figures to avoid excessive complexity.

These basic features as described above are common to all of the closing elements 1a-1f. However, some of the closing elements 1a-1f implement these features in different ways.

Referring to FIG. 1, a first closing element 1a includes first and second drives 10, 11 that are arranged concentrically with each other and with the vertical axis VA. The first drive 10 translates the closing head 8 along the stroke direction A. The second drive 11 rotates the closing head 8 along the rotation direction B.

The first and second drives 10, 11 are securely connected to the rotor 3 so that they are located above an upper side of the rotor 3, and therefore outside the area of the closing position 4. In filling-and-closing systems intended for aseptic or sterile filling and closing of containers 5, this region is exposed to a sterile medium. A typical sterile medium is a sterile gas or vapor, such as sterile air. Containers 5 move through this area so that their openings are exposed to the sterile medium.

In the illustrated embodiment, the first drive 10 is above the second drive 11. A guide device 12 guides the first drive 10. The guide device 12 includes two guide rods 13. The two guide rods 13 extend in a direction parallel to and radially offset from the vertical axis VA. The guide rods 13 pass through guide elements 14 located on the rotor 3. They do so in an axially displaceable manner.

Upper ends of the guide rods 13 project over the rotor 3 and extend past the second drive 11. A first transverse element 15 connects these upper ends together. The first drive 10 couples to the first transverse element 15.

The lower end of each guide rod 13 projects below an under side of the rotor 3. A second transverse element 16 connects the lower ends of the two guide rods 13 together. A closing-head shaft 17 passes through the second transverse element 16. This closing-head shaft 17 is mounted on bearings so that it can rotate about the vertical axis VA.

The lower end of the closing-head shaft 17 projects beyond an underside of the second transverse element 16. It is here that the closing head 8 is attached. A pressure spring 9 surrounding the closing-head shaft 17 is compressed between the closing head 8 and the second transverse element 16. This pressing spring 9 provides a closing pressure that enables the closing head 8 to bear down on the container 5.

The second drive 11 is a rotary drive or servo-drive having a second-drive shaft 18a that is coaxial with the vertical axis VA. The second-drive shaft 18a, which passes through a hole in the rotor 3, is mounted to rotate within a housing of the second drive 11. During the closing operation, the second-drive shaft 18a is constrained from movement parallel to the vertical axis VA.

At a lower end thereof, remote from the second drive 11, the second-drive shaft 18a becomes a hollow shaft having an internal space 19. An upper section of the closing-head shaft 17 extends into this space 19 so that the closing-head shaft 17 can be moved inside the space 19 relative to the second-drive shaft 18a in an axial direction during the stroke movement.

A dog catch 21 engages a slot 20 of the second-drive shaft 18a. The closing-head shaft 17 connects to the second-drive shaft 18a so that the second-drive shaft 18a can rotate the closing-head shaft 17 in the rotation direction B. A seal 22, shown only schematically in FIG. 1, seals the passage of the guide rods 13 through the rotor 3. In some embodiments, the seal 22 is a bellows seal.

Since the second-drive shaft 18a does not carry out any axial movement during the closing operation, the passage of the second-drive shaft 18a through the rotor 3 can be reliably sealed with a relatively simple seal. As a result, it is possible to enclose the sterile area surrounding the closing position 4 against the outside surroundings. This permits the first and second drives 10, 11 to be outside the sterile area, while nevertheless being reliably coupled to the closing head 8 within the sterile area.

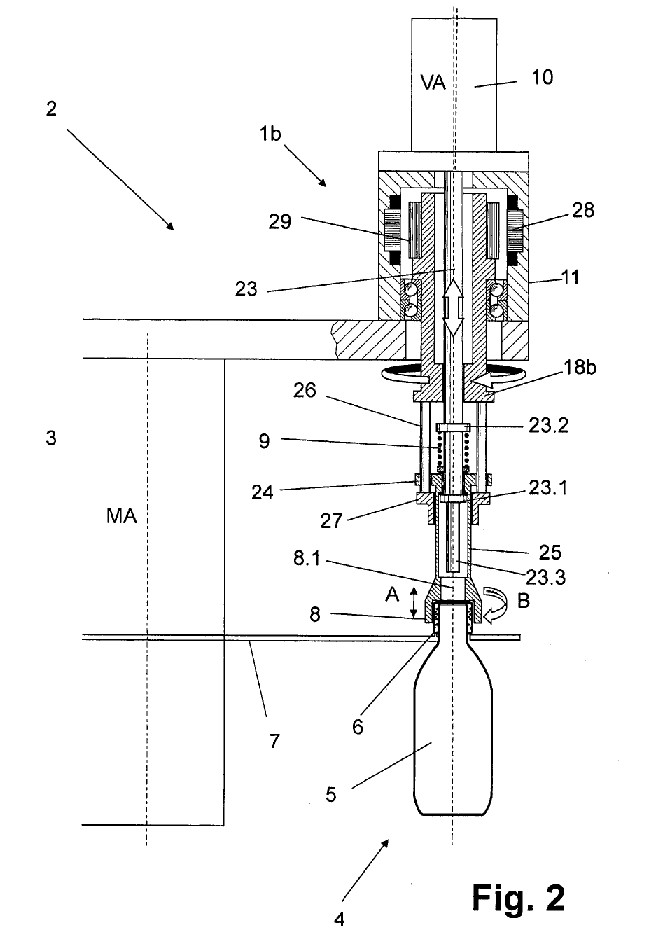

FIG. 2 shows a second closing element 1b having a first drive 10 and a second drive 11. The first drive 10 is a stroke drive. The second drive 11 is a rotary drive or an electrical servo-drive.

In this embodiment, the first drive 10 couples to an upper end of a stroke rod 23¹ that is coaxial with the vertical axis VA. The stroke rod 23 has a lower section that projects below an underside of the rotor 3. This lower section has a collar 23.1 that supports a guide piece 24. The guide piece 24 is part of a hollow closing-head shaft 25 that is coaxial with the vertical axis VA. The closing head 8 is secured to a lower end of the hollow closing-head shaft 25.

The guide piece 24 moves along the vertical axis VA. As it does so, guide rods 26, which are parallel to and radially offset from the vertical axis VA, guide the guide piece 24. At their upper ends, the guide rods 26 are secured to a lower face of a hollow second-drive shaft 18b of the second drive 11. Meanwhile, a ring 27 connects lower ends of the guide rods 26 to each other.

The closing head 8 and an upper collar 23.2 on the stroke rod 23 above the guide piece 24 cooperate to compress a spring 9 between them. This spring 9 provides the closing pressure needed to urge the closing head 8 to bear down against a container 5.

As FIG. 2 also shows, the second-drive shaft 18b forms the rotor of the second drive 11. In addition to being mounted to rotate in the housing of the second drive 11, the second-drive shaft 18b also supports rotor elements 29. These rotor elements 29 interact with an outer stator 28. Either a rotor winding or permanent magnets form the outer stator 28.

The first drive 10 uses the stroke rod 23 to cause the closing head 8 to carry out a stroke movement along a stroke direction A of the closing head 8. Meanwhile, the second drive 11 uses the guide rods 26, the guide piece 24 guided at these guide rods, and the hollow shaft 25 to rotate the closing head 8 in the rotation direction B. The second-drive shaft 18b of the second drive 11 does not moves axially during the operation, i.e. during the joining and fastening of the closure 6 to the container 5.

A lower portion of the stroke rod 23 projects downward beyond the lower collar 23.1 to form a plunger 23.3. When the closing head 8 is raised, the plunger 23.3 extends through an opening 8.1 and into the closing head 8. In doing so, the plunger 23.3 ejects any container closure 6 that remains in the closing head.

### Closing Element 1c

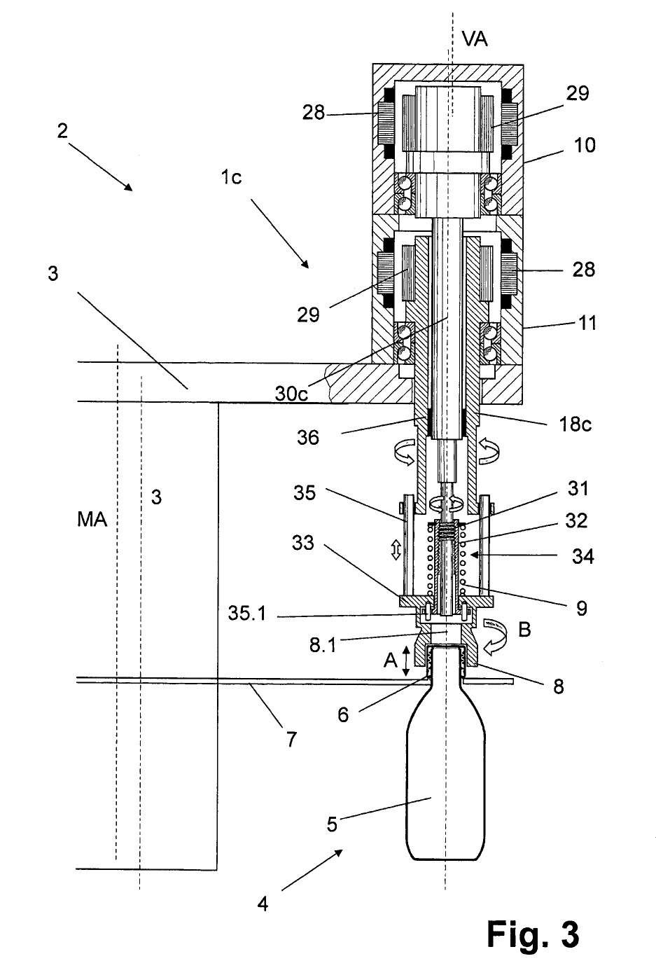

A third closing element 1c, shown in FIG. 3, features coaxial first and second drives 10, 11 disposed on an upper side of a rotor 3. In the particular embodiment shown, the first drive 10 sits above the second drive 11.

The first drive 10 is a rotary drive having a first-drive shaft 30c. A hollow second-drive shaft 18c of the second drive 11 encloses the first-drive shaft 30c. As a result, the first-drive shaft 30c and the second-drive shaft 11 are coaxial. A bearing 36 between the first-drive shaft 30c and the second-drive shaft 18c permits relative rotation between them.

A lower end of the first-drive shaft 30c forms a threaded spindle having a thread 31 that engages a threaded sleeve 32, both of which are coaxial with the vertical axis VA. The closing head 8 is secured to an under side of a ring 33 that is provided on this threaded sleeve 32.

The thread 31 interacts with an inner thread of the threaded sleeve 32 to form a stroke or spindle gear arrangement 34. This gear arrangement 34 converts rotational movement of the first-drive shaft 30c into stroke movement of the closing head 8 along a stroke direction A.

The ring 33 has an upper side that faces away from the closing head 8. Guide rods 35 parallel to and radially offset from the vertical axis VA project upward from this upper side. These guide rods 35 guide the ring 33 as it moves along the vertical axis VA at the lower end of the second-drive shaft 18c. In addition, the ring 33 can also be moved by a smaller stroke in the direction of the vertical axis VA relative to the threaded sleeve 32. Guide pins 35.1 secure the threaded sleeve 32 against rotation relative to the ring 33.

A pressing spring 9 surrounds the threaded sleeve 32 and extends between a collar at the upper end of the threaded sleeve 32 and the upper side of the ring 33. Relative movement between the threaded sleeve 32 and the ring 33 allows this pressing spring 9 to produce closing pressure necessary to bear down during closing of the containers 5.

A special feature of the third closing element 1c is that the first and second drives 10, 11 are both rotary drives. As such, they can be implemented as electrical servo-drives.

Another special feature of the third closing element 1c is that the second-drive shaft 18c and the first-drive shaft 30c, which in each case are mounted in the housings of the first and second drives 10, 11, both carry rotor elements 29 that interact with a corresponding stator windings 28. These rotor elements 29 are either rotor windings or permanent magnets.

Neither the second-drive shaft 18c nor the first-drive shaft 30c moves axially during the closing operation. As a result, it is much easier to seal a sterile region around the closing positions 4.

To cause stroke movement along a stroke direction A and to cause rotational movement in the rotation direction B, one simply controls movement of the first and second drives 10, 11 relative to each other and relative to the second-drive shaft 18c and the first-drive shaft 30c respectively.

To control the closing head's movement, the first drive 10 and the second drive 11 are simultaneously actuated in such a way that their rotational movements and behavior complement one another. Different rotational behavior of the first drive 10 and the second-drive 11 with their first-drive shaft 30c and second-drive shaft 18c necessarily leads to rotational angle displacement. The pitch of the thread 31 then converts this rotational angle displacement into stroke movement along a stroke direction A.

Relative movements between the first and second drives 10, 11 can also be used to raise the ring 33 to an extent such that a lower end of the first-drive shaft 30c enters the opening 8.1 in the closing head 8 to a depth great enough to eject any container closure 6 that might still remain there.

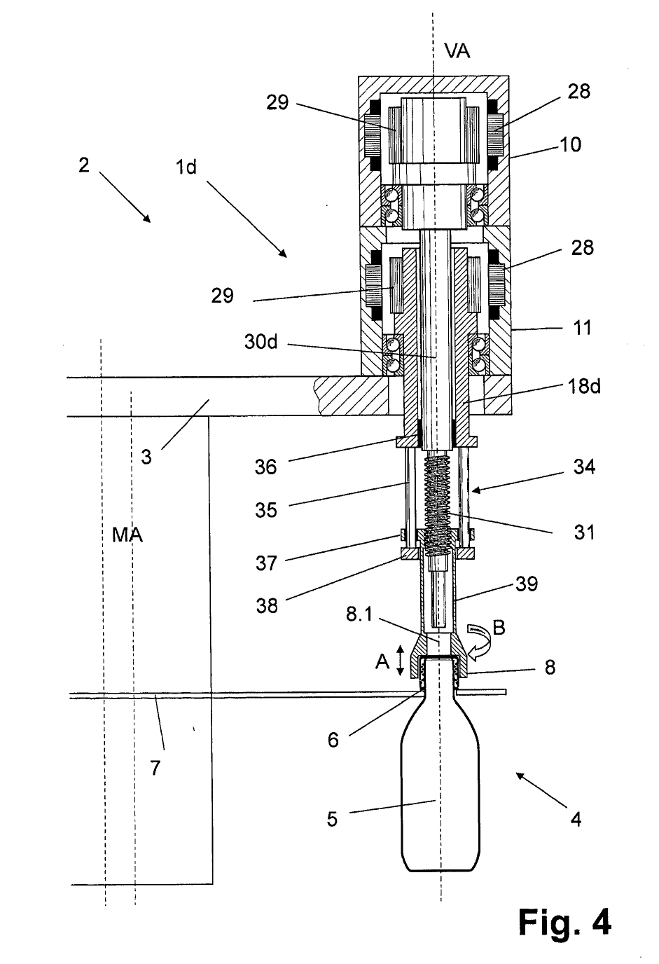

FIG. 4 shows as a fourth closing element 1d that differs from the third closing element 1c essentially only in that a thread 31 provided on a first-drive shaft 30d of a first drive 10 engages an inner thread that is provided on a first ring 37 that is guided axially on guide rods 35. Together, the first ring 37 and the thread 31, form stroke or spindle gears 34.

The guide rods 35 are securely connected by their upper ends to a lower end of a hollow second-drive shaft 18d of a second drive 11. A second ring 38 connects the guide rods 35 to each other at their lower ends.

The hollow second-drive shaft 18d encloses the first-drive shaft 30d. As a result, both the first-drive shaft 30d and the second-drive shaft 18d are coaxial with the vertical axis VA. Neither one moves axially while a closure 6 is being fastened to a bottle 5.

The first ring 37 is a constituent part of a hollow shaft 39 that is coaxial with the vertical axis VA. At its lower end, the hollow shaft 39 carries a closing head 8.

Controlled rotation of the second-drive shaft 18d and the first-drive shaft 30d relative to one another by way of the stroke or spindle gears 34 causes stroke movement along a stroke direction A. By way of the guide rods 35, it also causes rotational movement in the rotation direction B.

As was the case with the other embodiments described thus far, stroke movement can raise the closing head 8 along a stroke direction A far enough for the lower end of the first-drive shaft 30d to enter the closing head 8 through an opening 8.1. This permits ejection of any container closure 6 that may still be held by the closing head 8.

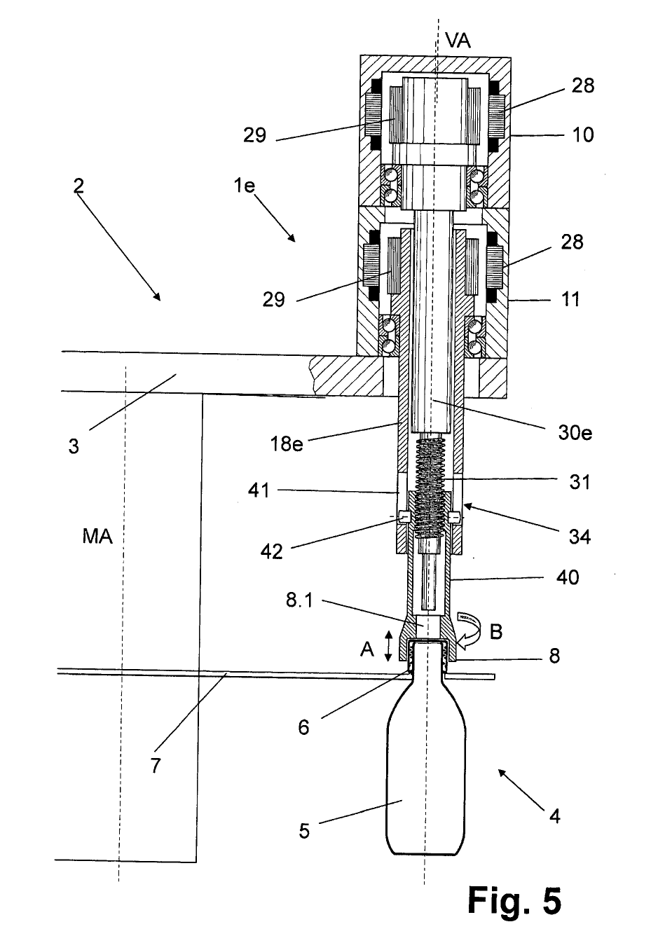

Referring now to FIG. 5, a fifth embodiment of a closing element 1e differs from the fourth closing element 1d essentially only in that the closing head 8 is provided at the lower end of a hollow shaft 40 having an upper section that, when displaced vertically, telescopes into a second-drive shaft 18e of the second drive 11, which is also a hollow shaft. The second-drive shaft 18e encompasses the first-drive shaft 30e. Both the second-drive shaft 18e and the first-drive shaft 30e are coaxial with the vertical axis VA. While the container closure 6 is being joined and fastened to the container 5, neither the second-drive shaft 18e nor the first-drive shaft 30e move axially.

An outer thread 31 of the first-drive shaft 30e engages an inner thread that is formed at the upper end of the hollow shaft 40, which has been accommodated in the second-drive shaft 18e. This inner thread and the outer thread 31 together form a stroke or spindle gear arrangement 34.

The second-drive shaft 18e is provided with slots 41 that extend along the vertical axis VA. Dog catches 42 of the hollow shaft 40 engage these slots 41. As a result, the first-drive shaft 30e becomes configured to be both freely displaceable axially relative to the second-drive shaft 18e and also locked to rotate with the second-drive shaft 18e. By suitably controlling relative movement between the first and second drives, and in particular, between the first-drive shaft 30e and the second-drive shaft 18e, it becomes possible to cause the closing head 8 to move along a stroke direction A and to rotate around a rotation direction B.

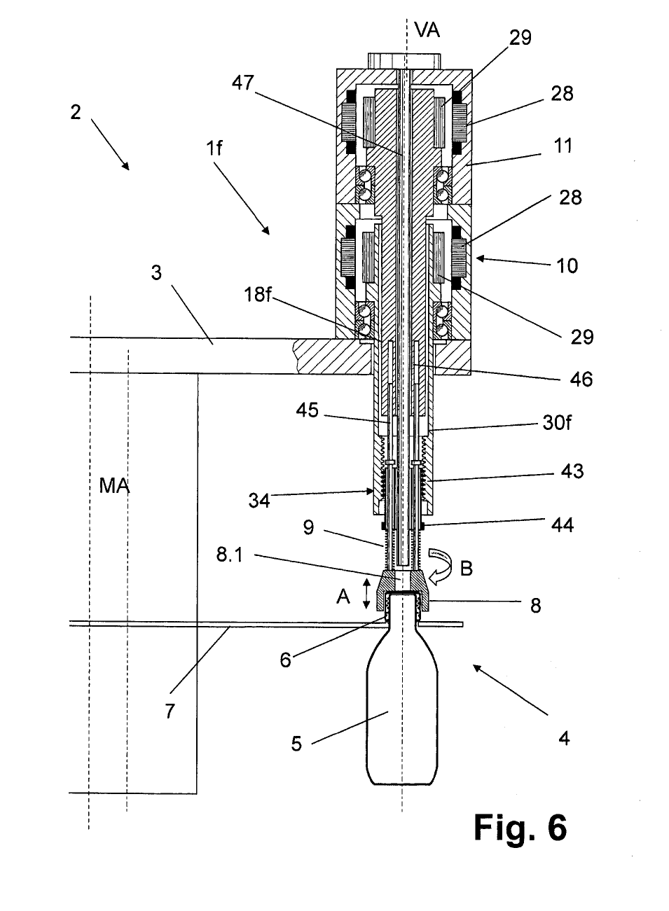

In a sixth closing element 1f, shown in FIG. 6, the second drive 11 is above the first drive 10. In this case, a first-drive shaft 30f of the first drive 10 is a hollow shaft that encompasses a second-drive shaft 18f of the second drive 11. The second-drive shaft 18f is likewise hollow and encompasses a plunger 47.

The first drive 10, the second drive 11, the second-drive shaft 18f, the first-drive shaft 30f, and the plunger 47 are all concentric with each other and coaxial with the vertical axis VA. During the closing operation, in particular during the joining and fastening of the closure 6, the second-drive shaft 18f and the first-drive shaft 30f do not move axially.

At its lower end, the first-drive shaft 30f has an inner thread 43 that engages a corresponding outer thread on a threaded element 44. Together, the inner thread 43 and the threaded element 44 form a stroke or spindle gear arrangement 34. Guide pins 45 extending parallel to the vertical axis VA and offset radially therefrom engage guide holes 46 of the second-drive shaft 18f. The threaded element 44 is displaced axially relative to the vertical axis VA. However, it remains coupled to the second-drive shaft 18f for rotation.

The guide pins 45 extend downward, through the threaded element 44, to the closing head 8. As a result, the closing head 8 also rotates with the second-drive shaft 18f so as to screw the closure 6 onto the container 5. Each guide pin 45 has a pressing spring 9 surrounding it. The pressing spring 9 presses against the closing head 8 and against the threaded element 44. In doing so, the pressing spring 9 provides a suitable closing pressure to assist in applying the closure 6 to the container 5.

The second-drive shaft 18f is part of the rotor of the second drive 11 and supports a rotor-side rotor element 29 that interacts with stator windings 28. Similarly, the first-drive shaft 30f is part of the rotor of the first drive 10 and also carries a rotor-side rotor element 29 that interacts with corresponding stator windings 28.

In some cases, a closure 6 may be left behind in the closing head. The plunger 47, which is not axially displaceable, carries out the task of ejecting any such stray closures 6. When the closing head 8 is raised, the plunger 47 is able to reach in and push out any container closure 6 that may remain in the closing head 8.

A feature that is common to all embodiments thus far is that the second-drive shaft 18a-18f avoids movement in the axial direction during the stroke movement of the closing head. In the case of the third through sixth embodiments of the closing elements 11c-11f, the first-drive shaft 30c-30f also avoids axial motion during the stroke movement of the closing head 8. In both cases, the result is an effective but simplified sealing of the passage of the drive shafts through the rotor 3, or any other partition wall for that matter. This results in a more effective seal where the containers are most vulnerable to contamination, namely while they are filled but still unsealed at the closing position 4.

The third through sixth closing elements 1c-1f, in which neither shaft moves axially during stroke movement, are particularly well-suited for use as aseptic closing elements. Among the advantages of these embodiments is that the first drive 10 and the second drive 11 are coaxial with each other and with the vertical axis VA. In part because they are securely connected to the rotor 3, during the closing operation, when a closure 6 is actually being joined or fastened to the container, the corresponding drive shafts do not move vertically along the vertical axis VA. Another advantage is that the first drive 10 and the second drive 11 are both located outside the closing positions 4, thus reducing the risk of contamination. Another advantage is that an independent drive provides stroke movement along a stroke direction A for each closing element of the closing machine. Yet another advantage is that the drive elements of the respective rotating drives, namely the second-drive shafts 18a-18c and the first-drive shafts 30c-30f, directly couple without any gear arrangement in between, are at the same time also part of the respective rotor of the electromotor drive. Accordingly, the second-drive shafts 18a-18f and the first-drive shafts 30c-30f are securely connected directly, without intermediate adjustment elements, to the rotors of the first drive 10 or the second drive 11.

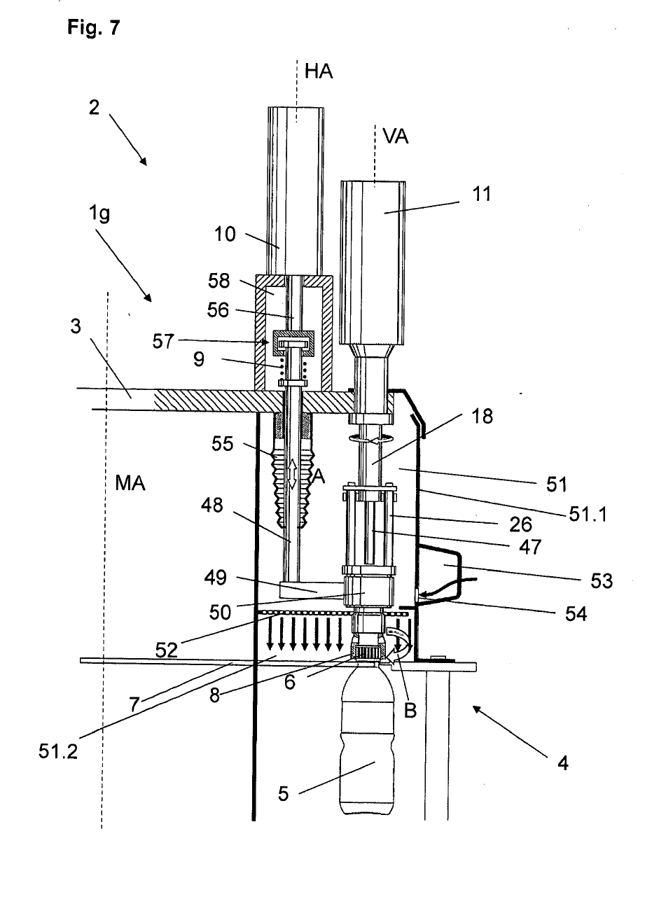

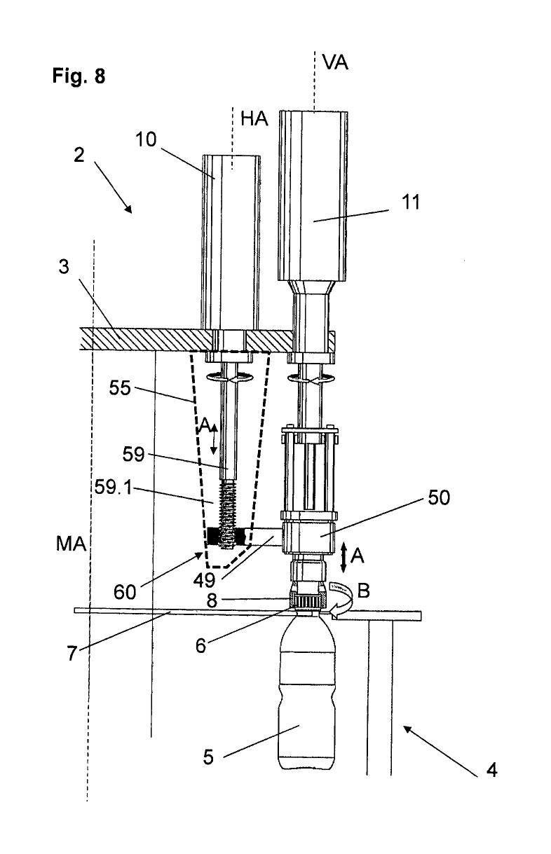

FIGS. 7 and 8 show two variants of the closing element in which the axis of the drive that causes controlled stroke movement is not concentric with the axis of the drive for causing controlled rotational movement of the closing head. Instead, these two axes are parallel but offset from each other. In the embodiment shown in FIG. 7, the second drive 11 has an axis coaxial with the vertical axis VA but the first drive 10 has a stroke-drive axis HA that is radially offset from the vertical axis VA. It is also possible to arrange the drives in the opposite way, with the first drive 10 being coaxial with the vertical axis VA. In addition, instead of the offset being in the radial direction as shown, the offset can also be in the circumferential direction.

FIG. 7 shows a seventh closing element 1g that, like the first closing element 1a, has a stroke rod 48. A coupling element 57 couples the stroke rod 48 to a first-drive shaft 56 of the first drive 10. The stroke rod 48 is coaxial with a stroke-drive axis HA of the first drive 10 for the controlled raising and lowering of the closing head 8. The stroke-drive axis HA is parallel to and offset from the vertical axis VA.

An arm 49 extends from the lower end of the stroke rode 48 towards a free end thereof at the vertical axis VA. A bearing arrangement 50 at the free end of the arm 49 permits rotation of guide rods 26 in a manner analogous to that described in the preceding embodiments, and in particular, in a manner analogous to that described in connection with the first and second closing elements 1a, 1b. The bearing arrangement 50 carries out a function that is analogous to that carried out by the transverse element 16 and the ring 27.

In the embodiment shown, a fixed non-rotating wall 51.1, a diffuser plate 54, and other rotation delimiting elements collectively define an upper isolator space 51. The stroke rod 48, the arm 49, the bearing 50, as well as the shaft 18 with the guide rods 26 all project into this upper isolator space 51.

The upper isolator space 51 comprises one or more inlets 54 that connect to either a common channel 53, as shown, or to delivery lines, either of which provide a supply of gas, such as sterile air, that can pass into the upper isolator space 51 through the inlets 54. The closing head 8 or the carrying shaft is guided through the diffuser plate 52 and into a lower isolator space 51.2 to promote gas flow in the region of the container closure 6 or the container mouth respectively.

A bellows 55 seals a region surrounding an aperture through which the stroke rod 48 passes through the rotor 3.

Just above where the stroke rod 48 passes through the rotor 3, there is a spring space 58 bounded by the rotor 3. Like the upper isolator space 51, the spring space 58 can be supplied with a sterile gas or a sterilizing medium. Within the spring space 58 is a spring element 9. The spring element bears against the coupling element 57 and the stroke rod 48. In doing so, the spring element 9 ensures a defined pressing force on the closing head 8 in a manner analogous to the pressing spring 9 described in connection with the second closing element 1b.

The upper isolator space 51, with its corresponding inlets and outlets, is described and shown only for the seventh closing element 1g. However, a similar upper isolator space 51 but in an analogous manner can advantageously also be provided for the other embodiments of the closing elements described.

FIG. 8 shows an eighth closing element 1h that differs from the seventh the closing element 1g essentially in that the drive 10 comprises a shaft 59 having, at a lower end thereof, a threaded section 59.1. The threaded section 59.1 accommodates and guides a counter thread 60 on an arm 49. Depending on its direction of rotation, the shaft 59 raises or lowers the bearing 50 and thereby raises or lowers the closing head 8.

A coupling and/or pressing spring, comparable to that already described in preceding embodiments, is also included but not shown. The spring causes a pressing force that urges the closing head 8 against the container 5.

An optional bellows element 55, represented by shading, encloses the entire shaft 59 and a section of the arm 49. As indicated heretofore, an isolator space can additionally be provided for.

An advantage of the embodiments shown in FIG. 7 or 8 is the simplified control that arises from having the external stroke drive's rotation be independent of the closing spindle's rotation. This simplifies control technology for an electrically simulated stroke curve sequence. In addition, motors with a simpler technology can be used. There is no need to use a hollow shaft motor as a closing matter, as is the case with the embodiments according to FIGS. 1 to 6.

Although the invention has been referred to and described herein in connection with rotation machines, wherein, the same principles can be used in linear machines or in-line closing units. The principle further applies to embodiments that have numerous modifications and derivations without thereby departing from the inventive thinking on which the invention is based.

Having described the invention, and a preferred embodiment thereof, what is new and secured by United States letters patent is:

1-11. (canceled)

12. An apparatus for closing bottles, said apparatus comprising a closure element for fastening a closure onto a bottle that is held parallel to a vertical axis, said closure element comprising a vertical axis, a closing head, a first drive, and a second drive, wherein said closing head accommodates said closure during placement and fastening thereof onto said bottle, wherein said first drive comprises a first-drive element that causes an axial stroke of said closing head, wherein said axial stroke results in movement of said closing head in a direction parallel to said vertical axis, wherein said axial stroke moves said closure element toward said bottle, wherein said second drive comprises a second-drive element that is connected to said closing head for causing said closing head to rotate about said vertical axis, thereby fastening said closure to said bottle, wherein said second-drive element comprises a second-drive shaft that is rotatable about said vertical axis, and wherein said second-drive shaft avoids axial movement during said axial stroke of said closing head.

13. The apparatus of claim 12, wherein said first drive comprises a first-drive shaft, and wherein said first-drive shaft and said second-drive shaft are coaxial with each other.

14. The apparatus of claim 12, wherein said first-drive element comprises a movable guide element that moves along said vertical axis during said stroke movement, wherein said closing head is rotatably mounted at said guide element, wherein said closing head is connected to said second-drive shaft in such a way that relative movement is possible between said second-drive shaft and said closing head in both a first direction and a second direction, wherein said first direction is a direction along said vertical axis during said stroke movement, and wherein said second direction is a rotational direction about said vertical axis during rotation of said second-drive shaft.

15. The apparatus of claim 14, further comprising a rotational coupling, wherein said rotational coupling connects said closing head to said second-drive shaft, thereby allowing said stroke movement.

16. The apparatus of claim 12, further comprising a spindle gear arrangement, wherein said second-drive element comprises a second-drive shaft, wherein said first-drive shaft is driven by said first drive about said vertical axis, wherein said second-drive shaft is driven by said second drive about said vertical axis, wherein, during said stroke movement of said closing head, said first-drive shaft does not move along said vertical axis, wherein, during stroke movement of said closing head, said second-drive shaft does not move along said vertical axis, wherein said spindle gear arrangement connects said first-drive shaft to said closing head, and wherein said spindle gear arrangement converts rotational movement into stroke movement.

17. The apparatus of claim 16, wherein said first-drive shaft and said second-drive shaft are arranged coaxially with one another and with said vertical axis, wherein said apparatus comprises a hollow-enclosing shaft and an enclosed shaft, wherein said hollow-enclosing shaft is selected from the group consisting of said first-drive shaft and said second-drive shaft.

18. The apparatus of claim 12, further comprising a plunger, wherein said plunger is disposed such that, when said closing head is raised during an axial stroke, said plunger extends into said closing head and ejects a closure that remains held therein.

19. The apparatus of claim 18, wherein said first-drive element comprises a stroke shaft, wherein said plunger is formed from a lower end of said stroke shaft.

20. The apparatus of claim 12, further comprising an aseptic filling and closing system, wherein said closing element is a constituent of said aseptic filling and closing system.

21. The apparatus of claim 12, further comprising a closing machine for closing bottles with screw-type closures, said closing machine comprising a rotor, wherein said closing element is one of a plurality of identical closing elements disposed on said rotor.

22. The apparatus of claim 21, wherein said closing head and said container are disposed in a first region, wherein said first and second drives of said closing element are disposed in a second region outside of said first region, wherein said second region is sealed from said first region, and wherein only drive elements of said first and second drives penetrate from said second region into said first region.

23. The apparatus of claim 12, wherein said first drive comprises a first-drive element, wherein said first-drive element avoids axial movement during said axial stroke of said closing head.

24. The apparatus of claim 12, wherein said first drive comprises a first-drive shaft, wherein said first-drive shaft avoids axial movement during said axial stroke of said closing head.

25. The apparatus of claim 13, wherein said first-drive shaft and said second-drive shaft are coaxial with said vertical axis.

26. The apparatus of claim 12, wherein said first-drive element comprises a plunger that can be moved along said vertical axis, wherein said closing head is rotatably mounted at said plunger and is connected in drive fashion to said second-drive shaft in such a way that relative movement is possible between said second-drive shaft and said closing head in both a first direction and a second direction, wherein said first direction is a direction along said vertical axis during said stroke movement, and wherein said second direction is a rotational direction about said vertical axis during rotation of said second-drive shaft.

27. The apparatus of claim 16, wherein said first-drive shaft and said second-drive shaft are arranged coaxially with one another and with said vertical axis, wherein said first-drive shaft encloses said second-drive shaft.

28. The apparatus of claim 12, wherein said first drive comprises a first-drive shaft, and wherein said first-drive shaft and said second-drive shaft are offset from each other.

28. The apparatus of claim 12, wherein said first-drive shaft and said second-drive shaft are offset from each other in a radial direction.

30. The apparatus of claim 12, wherein said first-drive shaft and said second-drive shaft are offset from each other in a circumferential direction.
